(19) United States
(12) Patent Application Publication
(10) Pub. No.: US 2024/0167396 A1
(43) Pub. Date: May 23, 2024

(54) TURBINE ENGINE EXHAUST DUCT SYSTEM AND METHODS FOR NOISE DAMPENING AND ATTENUATION

(71) Applicant: BJ Energy Solutions, LLC, The Woodlands, TX (US)

(72) Inventors: Ricardo Rodriguez-Ramon, The Woodlands, TX (US); Tony Yeung, The Woodlands, TX (US)

(73) Assignee: BJ Energy Solutions, LLC, The Woodlands, TX (US)

(21) Appl. No.: 18/517,822

(22) Filed: Nov. 22, 2023

Related U.S. Application Data
(60) Provisional application No. 63/384,840, filed on Nov. 23, 2022.

(51) Int. Cl. F01D 25/30; E21B 43/26

(52) U.S. Cl. CPC F01D 25/30; E21B 43/2607; F05D 2260/96

(57) ABSTRACT

An exhaust noise attenuation system and method for dampening and attenuation of noise from flows of exhaust gases from gas turbine engines such as for use in powering direct drive turbine fracturing systems includes an exhaust duct assembly, an upper noise attenuation assembly moveably mounted over an upper plenum portion of the exhaust duct assembly, and a conveying system. A flow path is defined along lower and upper plenum portions of the exhaust duct assembly and receives flows of exhaust gasses from the gas turbine engine. The conveying system is configured to selectively move the upper noise attenuation assembly between a stowed position substantially covering an outlet defined at an upper end of the upper plenum portion to prevent rain and snow from entering the exhaust duct assembly; and a deployed position in which the upper noise attenuation assembly is extended, extending the flow path of the exhaust gasses and redirecting the exhaust gasses away from the exhaust duct assembly and the gas turbine engine to enable a reduction of noise levels experienced at ground level.

### CROSS-REFERENCE TO RELATED APPLICATION

This application is a Non-Provisional patent application which claims priority to U.S. Provisional Application No. 63/384,840 filed Nov. 23, 2022, all of which is incorporated herein by reference in its entirety.

### TECHNICAL FIELD

In one aspect, the present disclosure relates to exhaust noise attenuation and dampening systems and methods; and in particular, to exhaust noise attenuation systems and methods for dampening and attenuation of noise from flows of exhaust gases from gas turbine engines of direct drive turbine fracturing systems.

### BACKGROUND

Hydraulic fracturing is often used to produce oil and gas in an economic manner from low permeability reservoir rocks, such as shale. During hydraulic fracturing, a fluid is pumped under high pressure into the reservoir rock, opening a flow channel, after which a proppant-carrying fluid is pumped into the flow channel to continue opening and widening the flow channel. Mechanical power for pumping such fluids may be generated by direct drive turbine fracturing units at a fracturing operation site, and due to the large nature of many fracturing operations, a number of direct drive turbine fracturing units often may be required at a fracturing operation site to ensure coverage for the fracturing operation. Such direct drive turbine fracturing units generally utilize gas turbine engines to generate power. However, such gas turbine engines also can generate substantial noise.

Accordingly, there exists a continued challenge to reduce the environmental impact of noise resulting from fracturing operations. The present disclosure is directed to systems and methods adapted to substantially reduce or alleviate noise generated by gas turbine engines at a fracturing operation site that address the foregoing and other related and unrelated problems/issues in the art.

### SUMMARY

Briefly described, the present disclosure is directed to exhaust noise attenuation and dampening systems and methods adapted to help substantially reduce, dampen, and/or attenuate noise generated by fracturing systems and/or components thereof during fracturing operations at a fracturing operation site. In embodiments, the exhaust noise attenuation and dampening systems and methods of the present disclosure can be configured to provide dampening and directional control of noise generated from exhaust gases produced by a gas turbine engine, e.g. as used to generate power for driving, driving one or more pumps, one or more electrical generators, and/or other operative components of a hydraulic fracturing unit by directing or channeling noise produced by the exhaust gases away from ground level to an exhaust elevated position; and to direct the exhaust gases away from an intake of the gas turbine engine.

Applicant has recognized that due to the nature of hydraulic fracturing, more horsepower than what is readily available at a fracturing operation site is often required. In other cases, due to site footprints, providing sufficient horsepower is the priority for covering all available space, and thus, having a dedicated generator may not be the best solution for power generation at such sites. Mobile power units can provide transportable power solutions for driving one or more hydraulic fracturing pumps and/or an electric power generators.

In some example embodiments of the present disclosure, a mobile power unit is provided, including embodiments of the exhaust noise attenuation and dampening systems and methods adapted to substantially dampen and/or alleviate noise generated by one or more engines of the mobile power unit. The mobile power unit can include a transportation platform (e.g., a trailer) on which various power generation components can be mounted for transport to a hydraulic fracturing site. In one embodiment or configuration, at least one gas turbine engine can be supported on the transportation platform for supplying power to a hydraulic fracturing pump. The gas turbine engine can have an engine output or drive shaft that can be configured to connect to a hydraulic fracturing pump the engine output shaft translating power from the gas turbine engine to the hydraulic fracturing pump to drive operation of the hydraulic fracturing pump to provide high pressure fluid for hydraulic fracturing operations. In some embodiments or configurations, an electrical generator can be provided on the transportation platform and connected to the gas turbine engine such that operation of the gas turbine engine drives the electrical generator to generate electrical power.

The exhaust noise attenuation and dampening system may be mounted along the transportation platform adjacent the gas turbine engine, and can include an exhaust duct assembly connected to the gas turbine engine and through which a flow of exhaust gases is received and directed along a flow path to a discharge position. In embodiments, the exhaust duct assembly may include an elongated lower plenum portion having proximal end with an inlet configured to receive the flow of exhaust gases from the gas turbine engine, and an upper plenum portion that can extend away from a distal end of the lower plenum portion. In embodiments, the upper plenum portion can be oriented and extend at an angle with respect to the lower plenum portion, defining a passage extending from the inlet and the proximal end of the lower plenum portion through the upper and lower plenum portions to an outlet at a distal end of the upper plenum portion.

In embodiments, the exhaust noise attenuation and dampening system further includes an upper attenuation assembly received and moveably mounted over the upper plenum portion of the exhaust duct assembly adjacent the distal end thereof; and a conveying system coupled to the upper attenuation assembly. The conveying system will be configured to selectively move the upper attenuation assembly between a first, non-active or stowed position, in which a discharge end of the upper attenuation assembly is positioned proximate to the distal end and outlet of the upper plenum portion; and a second, raised or deployed position, in which the upper attenuation assembly defines an elongated upper plenum portion in fluid communication with the lower plenum portion and in which the discharge end of the upper attenuation assembly is spaced away from the lower plenum portion with an outlet or exhaust opening thereof is exposed.

In embodiments, the upper attenuation assembly can have a body connected to the conveying system, which can selectively move the body in relation to the upper plenum portion of the exhaust duct assembly between the stowed and deployed positions. portion. When the upper attenuation assembly is in its deployed position, an extended flow path can be created along which the exhaust gases received from the gas turbine engine and passing through the upper and lower plenum portions of the exhaust duct assembly will be further directed away from an intake of the gas turbine engine and away from ground level so that noise experienced at ground level can be reduced.

By directing the exhaust gases along an extended flow path, at least some of the energy of the exhaust gases is enabled to dissipate or be reduced to help achieve a reduction in noise generated by the exit of the exhaust gases from the outlet or exhaust opening of the upper attenuation assembly. In addition, when the upper attenuation assembly is moved to its deployed position, the outlet or exhaust opening of the upper attenuation assembly generally will be exposed or placed in an open state, enabling discharge of the exhaust gases at a higher elevation that is spaced vertically from ground level sufficient to enable a substantial dampening or attenuation of noise to which workers and other personnel at ground level are exposed and/or experience as the exhaust gases are discharged.

In embodiments, the body of the upper attenuation assembly can include a support structure or frame, and a plurality of upstanding walls terminating at a discharge end at which the outlet or exhaust opening is defined. In some embodiments, the body of the upper attenuation assembly can include a series of fixed walls mounted along two or more sides of the support structure; and can have at least one movable wall that can be pivotally attached to the support structure. The at least one moveable wall can be movable between a first, raised position in which the movable wall defines an upper panel or wall configured to substantially cover the outlet or exhaust opening when the upper attenuation assembly is in its stowed position upper plenum portion; and a second, lowered position exposing the outlet or exhaust opening and enabling discharge of the exhaust gases when the upper attenuation assembly is moved to its deployed position.

In some embodiments, a pair of movable walls can be provided, each being pivotally attached to the support structure adjacent an upper end thereof. Each of the moveable walls can be movable between a first, raised position substantially covering the outlet or exhaust opening when the upper attenuation assembly is in its stowed position; and a second, lowered position exposing the outlet or exhaust opening and enabling release of the exhaust gases therefrom when the upper attenuation assembly is moved to its deployed position.

In embodiments, the movable walls of the upper attenuation assembly can be pivotally attached at their upper ends to the frame, and can be mounted to rollers located at their lower ends. The rollers can be configured to roll along an upper surface at the distal end of the upper plenum portion as the upper attenuation assembly is moved to its deployed position. For example, as the upper attenuation assembly is raised by the conveying system, the rollers can move in a first direction to cause the movable wall or movable walls to pivot towards their lowered positions; and as the upper attenuation assembly is moved in an opposite direction, toward its stowed position, the rollers can move in a second, opposite direction, causing the movable wall or movable walls to pivot towards their raised positions. When the moveable wall or walls are in the raised position, they can form a cover that can substantially close the outlet or exhaust opening of the upper attenuation assembly and the outlet of the upper plenum portion, which can protect the exhaust duct assembly from rain, debris, snow, etc. during transport and when not in use.

In embodiments, the conveying system can include one or more actuators coupled to the upper attenuation assembly. For example, a pair of actuators can be provided on each side of the upper attenuation assembly (e.g., along a frame of the conveying system that is coupled to the body of the upper attenuation assembly). The actuators can be operated to selectively move the upper attenuation assembly along a substantially vertical path of travel between its stowed and deployed positions. In embodiments, the actuators can include hydraulic or pneumatic actuators, rotary actuators, motors, such as servo motors and/or torque motors, and/or electric actuators.

In embodiments, the conveying system further can include a guide system adapted to help guide the substantially vertical movement of the upper attenuation assembly. In some embodiments, the guide system can include a series of tubular guides that can be mounted to the frame of the conveying system, or, in other embodiments, can be mounted to the body of the upper attenuation assembly. In embodiments, the guide system can include a series of frame members having guide slots or pathways along which guide plates, brackets, rollers or other, similar guides can be received to control and guide movement of the upper attenuation assembly.

In other embodiments, the conveying system can include a series of telescoping vertical supports attached to the body of the upper attenuation assembly, with the actuators of being connected to the body of the upper attenuation assembly or to braces or cross supports between the vertical supports. In addition, a series of bearing assemblies can be provided adjacent upper and/or lower ends of the outer tubes of the telescoping vertical supports. The bearing assemblies can be configured to ride along the inner tubes of the telescoping supports to help guide vertical movement of the outer telescoping tubes during movement of the upper attenuation assembly between its stowed and deployed positions.

In other embodiments, the body of the upper attenuation assembly can include a series of substantially fixed walls, at least one sloped or angled wall, and a substantially flat top or upper wall extending between the fixed walls. An outlet or exhaust opening can be defined between the upper end of the sloped or angled wall of the body and the upper or top wall. When the upper attenuation assembly is in its stowed position, the upper wall can substantially cover the outlet of the upper plenum portion of the exhaust duct assembly. When the upper attenuation assembly is moved to its deployed position above the upper plenum portion, the exhaust gases are enabled to flow along the extended flow path and discharged through the outlet or exhaust opening. In addition to providing an extended flow path for the exhaust gases such that the exhaust gases are discharged at a higher elevation above ground level and enabling dissipation of energy of the exhaust gases, the angled wall also can be configured to redirect the exhaust gases upwardly and outwardly at an angle, away from an intake of the gas turbine engine and/or other operative components of the mobile power unit.

In still another embodiment, the body of the upper attenuation assembly can include a series of outwardly sloping or angled walls that define a flared outlet or exhaust opening at the discharge end of the upper attenuation assembly. A cover or upper wall can be arranged between the walls adjacent the outlet or exhaust opening, and can be configured to substantially seat over and cover the outlet of the upper plenum portion when the upper attenuation assembly is in its stowed position. When the upper attenuation assembly is moved to its deployed position, the outlet of the upper plenum portion will be exposed, allowing the exhaust gases to flow from the upper plenum portion through the upper attenuation assembly and be discharged to the surrounding environment. The sloped configuration of the walls of the body of the upper attenuation assembly and the positioning of the cover between the upper ends thereof further can enable the flow of exhaust gases to expand or spread, which can help dissipate at least some of the energy thereof helping to reduce the level of noise generated as the exhaust gases are discharged. At the same time, the exhaust gases will be directed further upwardly and away from ground level for discharge of the exhaust gases at a higher elevation with respect to ground level to enable a substantial dampening or attenuation of noise to which workers and other personnel at ground level are exposed and/or experience as the exhaust gases are released to the surrounding environment.

According to one aspect of the disclosure, a hydraulic fracturing unit for pumping a fracturing fluid into a well-head is provided, the hydraulic fracturing unit comprising a chassis; a fracturing pump positioned on the chassis and configured to pump the fracturing fluid into the well-head; a gas turbine engine positioned on the chassis, and operatively connected to the fracturing pump; the gas turbine engine configured to receive a fuel mixture and to combust at least a portion of the fuel mixture; wherein the gas turbine engine drives operation of the fracturing pump to pump the fracturing fluid into the wellhead; an exhaust noise attenuation system, comprising an exhaust duct assembly including a lower plenum portion coupled to the gas turbine engine, and configures to receive a flow of exhaust gases therefrom, and an upper plenum portion downstream from the lower plenum portion and having an exhaust opening at a distal end thereof; wherein a flow path along which the flow of exhaust gases is moved is defined through the lower and upper plenum portions; an upper attenuation assembly received over the distal end of the upper plenum portion; and a conveying system coupled to the upper attenuation assembly and configured to the upper attenuation assembly between a stowed position substantially covering the exhaust opening of the upper plenum portion, and a second position enabling release of exhaust from the exhaust duct; wherein upon movement of the upper attenuation assembly to its deployed position, the flow path of the exhaust gas through the exhaust duct and upper attenuation assembly is extended to increase a length of travel of the flow of exhaust gases and redirect the flow of exhaust gases away from ground level to facilitate a reduction of noise generated by release of the exhaust gases experienced at ground level.

In an embodiment of the hydraulic fracturing unit, the conveying system comprises a frame and at least one actuating mechanism coupled to the upper attenuation assembly and configured to move the upper attenuation assembly along a substantially vertical path of travel between its stowed and deployed positions.

In an embodiment of the hydraulic fracturing unit, the at least one actuating mechanism comprises a hydraulic or pneumatic cylinder, an electric actuator, rotary actuator, or motor.

In some embodiments of the hydraulic fracturing unit, the conveying system further comprises a guide system within which the upper attenuation assembly is received, the guide system being configured to guide the upper attenuation assembly along its substantially vertical path of travel.

In an embodiment of the hydraulic fracturing unit, the upper attenuation assembly comprises a body having a frame, a plurality of substantially vertically extended walls, at least one moveable wall plurality attached to the frame, and one or more rollers connected to the at least one moveable wall and configured to move along a portion of the upper plenum portion adjacent the exhaust opening thereof so as to move the at least one moveable wall between a closed position substantially covering the exhaust opening and an open position to expose an outlet or exhaust opening defined at an upper end of the upper attenuation assembly and through which the flow of exhaust gases is discharged when the upper attenuation assembly in its second position.

In some embodiments, the at least one moveable wall comprises first and second moveable walls, each pivotally attached at an upper end of the frame of the body of the upper attenuation assembly.

In an embodiment of the hydraulic fracturing unit, the upper attenuation assembly comprises a body having a plurality of substantially vertically extending side walls, at least one angled wall, and a substantially horizontally extending top wall; wherein an outlet or exhaust opening is defined between the top wall and an upper end of the at least one angled wall; and wherein as the flow of exhaust gases is directed along the extended flow path, the exhaust gases are redirected upwardly and at an angle away from the exhaust assembly.

In an embodiment of the hydraulic fracturing unit, the upper attenuation assembly comprises a body having a plurality of sloping side walls and a top plate positioned therebetween and configured to at least partially cover the exhaust opening of the upper plenum portion when the upper attenuation assembly is in its stowed position.

In an embodiment of the hydraulic fracturing unit, the upper attenuation assembly comprises a body having a frame and series of substantially vertically extending walls; wherein the conveying system comprises a series of actuating mechanisms coupled to the of the body of the upper attenuation assembly and configured to move the frame along a substantially vertical path of travel; and further comprising a guide system within which the body of the upper attenuation assembly is received, the guide system including a series of guide members configured to guide movement of the upper attenuation assembly as the upper attenuation assembly is moved between its stowed and deployed positions.

In an embodiment of the hydraulic fracturing unit, the conveying system comprises a plurality of telescoping supports coupled to the upper attenuation assembly, and at least one actuating mechanism coupled to the upper attenuation assembly and configured to move the upper attenuation assembly along a substantially vertically path of travel between its stowed and deployed positions.

In another aspect of the disclosure, an exhaust noise attenuation system is provided, comprising an exhaust duct assembly comprising a lower plenum portion having a proximal end and a distal end, and an inlet adjacent its proximal end configured to receive a flow of exhaust gases from an engine; and an upper plenum portion having a proximal end adjacent the distal end of the lower plenum portion and a distal end terminating at outlet; wherein a flow path for the flow of exhaust gases is defined through the upper and lower plenum portion; and an upper noise attenuation assembly movably connected to the upper plenum portion, the upper noise assembly comprising a body having a proximal end, distal end, a plurality of walls, and an exhaust opening defined at the distal of the body; and a conveying system including one or more actuators coupled to the body and configured to selectively move the upper noise attenuation assembly between a stowed position, at which the upper attenuation system is configured to substantially cover the outlet of the upper plenum portion, and a second position, at which the upper attenuation assembly is elevated above the exhaust opening of the upper plenum portion so as to define an extended flow path in fluid communication with the outlet of the upper plenum portion and along which the flow of exhaust gases is for discharge at a raised elevation above ground level so as to reduce a level of noise heard at the ground level.

In an embodiment of the exhaust noise attenuation system, the exhaust duct assembly and upper noise attenuation assembly are mounted along a trailer of a mobile power generation unit.

In an embodiment of the exhaust noise attenuation system, the upper attenuation assembly comprises a body having a frame, a plurality of substantially vertically extended walls, at least one moveable wall plurality attached to the frame, and one or more rollers connected to the at least one moveable wall and configured to move along a portion of the upper plenum portion adjacent the exhaust opening thereof so as to move the at least one moveable wall between a closed position substantially covering the exhaust opening and an open position to expose an outlet or exhaust opening defined at an upper end of the upper attenuation assembly and through which the flow of exhaust gases is discharged when the upper attenuation assembly in its second position.

In some embodiments, the at least one moveable wall comprises first and second moveable walls, each pivotally attached at an upper end of the frame of the body of the upper attenuation assembly.

In an embodiment of the exhaust noise attenuation system, the conveying system comprises a frame and at least one actuating mechanism coupled to the upper attenuation assembly and configured to move the upper attenuation assembly along a substantially vertical path of travel between its stowed and deployed positions.

In some embodiments, the at least one actuating mechanism comprises a hydraulic or pneumatic cylinder, an electric actuator, rotary actuator, or motor.

In an embodiment of the exhaust noise attenuation system, the upper attenuation assembly comprises a body having a plurality of substantially vertically extending side walls, at least one angled wall, and a substantially horizontally extending top wall; wherein an outlet or exhaust opening is defined between the top wall and an upper end of the at least one angled wall; and wherein as the flow of exhaust gases is directed along the extended flow path, the exhaust gases are redirected upwardly and at an angle away from the exhaust assembly.

In an embodiment of the exhaust noise attenuation system, the upper attenuation assembly comprises a body having a plurality of sloping side walls and a top plate positioned therebetween and configured to at least partially cover the exhaust opening of the upper plenum portion when the upper attenuation assembly is in its stowed position.

In an embodiment of the exhaust noise attenuation system, the conveying system comprises a plurality of telescoping supports coupled to the upper attenuation assembly, and at least one actuating mechanism coupled to the upper attenuation assembly and configured to move the upper attenuation assembly along a substantially vertically path of travel between its stowed and deployed positions.

In an embodiment of the exhaust noise attenuation system, the upper attenuation assembly comprises a body having a frame and series of substantially vertically extending walls; wherein the conveying system comprises a series of actuating mechanisms coupled to the of the body of the upper attenuation assembly and configured to move the frame along a substantially vertical path of travel; and further comprising a guide system within which the body of the upper attenuation assembly is received, the guide system including a series of guide members configured to guide movement of the upper attenuation assembly as the upper attenuation assembly is moved between its stowed and deployed positions.

According to another aspect, an exhaust noise attenuation system comprises an exhaust duct assembly comprising a lower plenum portion defining an inlet for a flow path along which a flow of exhaust gases is received; and an upper plenum portion downstream of the lower plenum portion and defining a continuation of the flow path; and an upper noise attenuation assembly located adjacent an outlet defined at a distal end of the upper plenum portion, the upper noise assembly comprising a body having a frame, a plurality of walls attached to the frame and an exhaust opening defined at an upper end of the walls and configured to discharge the flow of exhaust gases; and a conveying system coupled to the body and configured to selectively move the body between a stowed position in which fluid communication between the exhaust opening and the flow path is substantially closed, and a deployed position in which the body is moved to an extended position and fluid communication between the exhaust opening and the flow path defined through the lower plenum portion and the upper plenum portion is opened; wherein when the body of the upper attenuation assembly is in its deployed position, the flow path defined though the lower plenum portion and upper plenum portion is extended and directed away from the exhaust duct assembly toward a discharge position at a raised elevation above a ground level so as to reduce a level of noise experienced at the ground level.

In an embodiment of the exhaust noise attenuation system, the exhaust duct assembly is mounted on a chassis of a mobile power generation unit, and is in fluid communication with a gas turbine engine mounted on the chassis.

In embodiments, the walls comprise one or more moveable walls configured to transition between a first position substantially covering the outlet of the upper plenum portion when the body of the upper noise attenuation assembly is in the stowed position and a second position in which the exhaust opening and the outlet of the upper plenum portion are exposed to enable discharge of the flow of exhaust gases.

In embodiments, the exhaust noise attenuation further comprises pivot pins configured to pivotally couple a first end of the one or more moveable walls to an upper end of the frame such that the one or more moveable walls are pivoted between their first and second positions when the body is moved between the stowed and deployed positions.

In some embodiments, as the body of the upper noise attenuation assembly is moved toward its deployed position, the one or more moveable walls move inwardly and downwardly with respect to the upper plenum portion, with the first end of the one or more moveable walls pivoting about the pivot pins toward substantial alignment with corresponding walls of the upper plenum portion so that they extend substantially parallel to the walls of the upper plenum portion of the exhaust duct assembly.

In embodiments, the exhaust noise attenuation system further comprises a guide system configured to receive the frame of the upper attenuation assembly, the guide system comprising a plurality of guide members configured to guide movement of the upper attenuation assembly as the upper attenuation assembly is moved between its stowed and deployed positions.

In embodiments, the guide system further comprises a plurality of guide wheels being moveable along the guide members of the guide system, and one or more guide wheel blocks located adjacent the guide wheels to help guide the guide wheels along the guide members of the guide system.

In some embodiments, the guide system further comprises one or more stops positioned along the guide members and configured to limit an amount of travel of the guide wheels; wherein the one or more stops are moveable for adjusting the amount of travel of the upper attenuation assembly.

In an embodiment of the exhaust noise attenuation system, the conveying system comprises one or more actuators configured to selectively move the upper noise attenuation assembly between its stowed position and its deployed position.

In an embodiment of the exhaust noise attenuation system, the plurality of walls comprise a plurality of fixed, substantially vertically extending side walls, at least one angled wall, and a substantially horizontally extending top wall; wherein the exhaust opening is defined between the top wall and an upper end of the at least one angled wall; and wherein as the flow of exhaust gases is directed along the extended flow path, the exhaust gases are redirected upwardly and at an angle away from the exhaust duct assembly.

In an embodiment of the exhaust noise attenuation system, the plurality of walls comprise a series of sloping side walls, and the body further comprises a top plate positioned between the sloping side walls, wherein the top plate is configured to at least partially cover the outlet of the upper plenum portion when the body of the upper attenuation assembly is in its stowed position.

In an embodiment of the exhaust noise attenuation system, the conveying system comprises a series of actuating mechanisms coupled to the of the body of the upper attenuation assembly, the actuating mechanisms configured to move the body along a substantially vertical path of travel; and further comprising a guide system within which the body of the upper attenuation assembly is received, the guide system including a series of guide members configured to guide movement of the body as the body is moved between the stowed and deployed positions.

In an embodiment of the exhaust noise attenuation system, the conveying system comprises a plurality of telescoping supports coupled to the body of the upper attenuation assembly, and at least one actuating mechanism coupled to the body and configured to move the body along a substantially vertically path of travel so as to move the body of the upper attenuation assembly between its stowed and deployed positions.

Accordingly, various aspects and embodiments of exhaust noise attenuation and dampening systems and methods adapted to substantially reduce or alleviate noise generated by gas turbine engines are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced. Those skilled in the art further will appreciate and understand that, according to common practice, the various features of the drawings discussed below are not necessarily drawn to scale, and that the dimensions of various features and elements of the drawings may be expanded or reduced to more clearly illustrate the embodiments of the present disclosure described herein.

FIG. 1 is a perspective view of a mobile power unit according to an embodiment of the disclosure.

FIGS. 2A-2B are isometric views of an embodiment of an exhaust noise attenuation system shown in closed and open positions according to the principles of the present disclosure.

FIG. 2C is an isometric view of the upper noise attenuation section of the exhaust noise attenuation system of FIGS. 2A-2B in an extended, opened position with intermediate walls thereof oriented at an angle.

FIGS. 3A-3B are isometric views of an additional embodiment of an exhaust noise attenuation system shown in closed and open positions according to the principles of the present disclosure.

FIGS. 4A-4B are isometric views of another embodiment of an exhaust noise attenuation system shown in closed and open positions according to the principles of the present disclosure.

FIGS. 5A-5B are isometric views of an alternative embodiment of the exhaust noise attenuation system shown in FIGS. 4A-4B, illustrated in closed and open positions, according to the principles of the present disclosure.

FIGS. 6A-6B are isometric views of still another embodiment of an exhaust noise attenuation system shown in closed and open positions according to the principles of the present disclosure.

FIG. 7 is a side elevational view schematically illustrating an embodiment of a vertical conveyor assembly for controlling movement of an upper noise attenuation section of the exhaust noise attenuation system according to the principles of the present disclosure.

FIGS. 8A-8B are isometric views of a roller device for causing movement of an exhaust duct flange, such as shown FIGS. 3A-6B, according to principles of the present disclosure.

FIGS. 9A-9B are isometric views illustrating a pivot portion about which an exhaust duct flange, such as shown FIGS. 3A-6B, is pivoted when moving between an extended, open position, and a closed, retracted position, in accordance with principles of the present disclosure.

FIGS. 10A-10B are isometric view of an embodiment of a guide system for guiding movement of the upper noise attenuation section of the exhaust noise attenuation system between an extended, open position and a closed, retracted position, according to the principles of the present disclosure.

FIGS. 11A-11D are isometric views of the guide system of FIGS. 10A-10B, schematically showing movement of the upper noise attenuation section to its extended, open position, in accordance with the principles of the present disclosure.

FIG. 12 is an isometric view of a close-up of the guide system of FIGS. 10A-11D.

FIG. 13 is an isometric view of an additional embodiment of a connection between the conveying system, and the guide system to the upper noise attenuation section of the exhaust noise attenuation system.

### DETAILED DESCRIPTION

The present disclosure will now be described more fully hereinafter with reference to example embodiments thereof with reference to the drawings in which like reference numeral designate identical or corresponding elements in each of the several views. These example embodiments are described so that this disclosure will be thorough and complete, and will fully convey the scope of the disclosure to those skilled in the art. Features from one embodiment or aspect may be combined with features from any of the embodiment or aspect in any appropriate combination. For example, any individual or collective features of method aspects or embodiments may be applied to apparatus, product, or component aspects or embodiments and vice versa. The disclosure maybe embodied in many different forms and should not be construed as limited to the embodiments set forth herein; rather, these embodiments are provided so that this disclosure will satisfy applicable legal requirements. As used in the specification and the appended claims, the singular forms “a”, “an”, “the”, and the like include plural referents unless the context clearly dictates otherwise. In addition, while reference may be made herein to quantitative measure, values, geometric relationships or the like, unless otherwise stated, any one of more if not all of these may be absolute or approximate to account for acceptable variations that may occur, such as those due to manufacturing or engineering tolerances or the like.

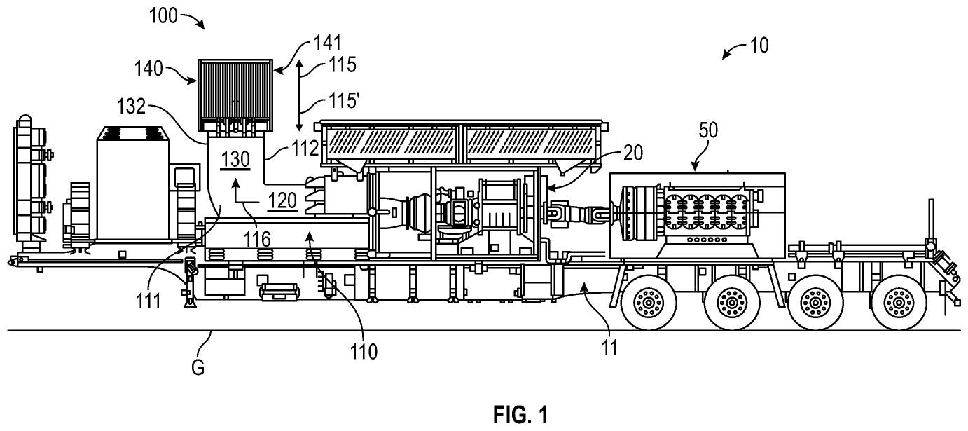

FIGS. 1-13 illustrate an example mobile power unit and various embodiments of exhaust noise attenuation and dampening systems 100 and methods for dampening and attenuation of noise generated by exhaust gases produced by an engine for generation of power. In one example embodiment, the exhaust noise attenuation systems 100 may include systems, apparatus, and methods for discharging exhaust gases and for providing noise dampening and attenuation of such exhaust gases from an engine of a mobile power unit such as can be used at fracturing operation sites, or other sites.

FIG. 1 illustrates an exemplary mobile power unit 10 that can incorporate embodiments of the exhaust noise attenuation and dampening system 100 in accordance with the present disclosure, and which selectively may be provided with either a fracturing pump 50 or an electrical generator. The mobile power units 10 further can include a gas turbine engine 20 that provides mechanical horsepower to drive the fracturing pump or an electrical generator, which also may be generally referred to as the “drive equipment.” The hydraulic fracturing pump and electrical generator also can be designed as modular components that may be removed and replaced with another pump or generator without modifying the remainder of the mobile power unit 10.

As shown in FIG. 1, the mobile power unit can include a transportation platform 11, e.g., a chassis or trailer with a flat bed or supporting surface on which the drive equipment of the mobile power unit 10 is received and supported. In FIG. 1, the transportation platform 11 is shown as a single trailer with the mobile power unit 10 and various operative components thereof mounted or installed therealong, though more than one trailer also can be used. The transportation platform further may be pulled by a tractor (not shown) on and off public highways as will be understood by those skilled in the art. In some embodiments, the transportation platform may include more than one trailer.

One skilled in the art will appreciate that the gas engine 20 may be configured to generate mechanical energy (i.e., rotation of a shaft) by combustion of air and a hydrocarbon fuel source, such as natural gas, liquefied natural gas, condensate, and/or other liquid fuels. As schematically illustrated, the gas turbine engine can have a drive shaft connected to a gearbox that converts the mechanical energy from the rotation of the gas turbine shaft to operate a downstream mechanically connected hydraulic fluid pump 50 at a desired speed and torque. The engine may be a gas turbine engine, such as the GE family of gas turbine engines, the Pratt and Whitney family of gas turbine engines, or any other gas turbine engines and/or dual-fuel turbine engines that generate sufficient mechanical power for the production of the desired level of horsepower to the downstream fluid pump for fracking operations.

In embodiments, the engine 20 further may include any suitable engine including, but not limited to, an internal combustion engine or a gas turbine engine. The engine 20 may be a dual fuel engine operating on gasoline, natural gas, well gas, field gas, diesel, and/or other suitable fuel. In some embodiments, the engine may be a dual fuel engine operating on a liquid fuel and a gaseous fuel. In certain embodiments, the engine is a dual fuel gas turbine engine that asynchronously operates on diesel fuel, e.g., #2 diesel as will be understood by those skilled in the art, and on a gaseous fuel, e.g., natural gas, well gas, or field gas. In particular embodiments, the engine is a dual fuel, dual shaft gas turbine engine that operates on a liquid fuel such as diesel fuel and a gaseous fuel such as natural gas, well gas, or field gas.

Examples of mobile power units that can be utilized with the exhaust noise attenuation and dampening systems 100 and methods for noise dampening and attenuation according to embodiments of the present disclosure can include mobile power units such as illustrated and described in U.S. Pat. No. 11,125,066 and United States Patent Publication US 20210381358A1, the disclosures of which are incorporated herein as if fully set forth in their entireties.

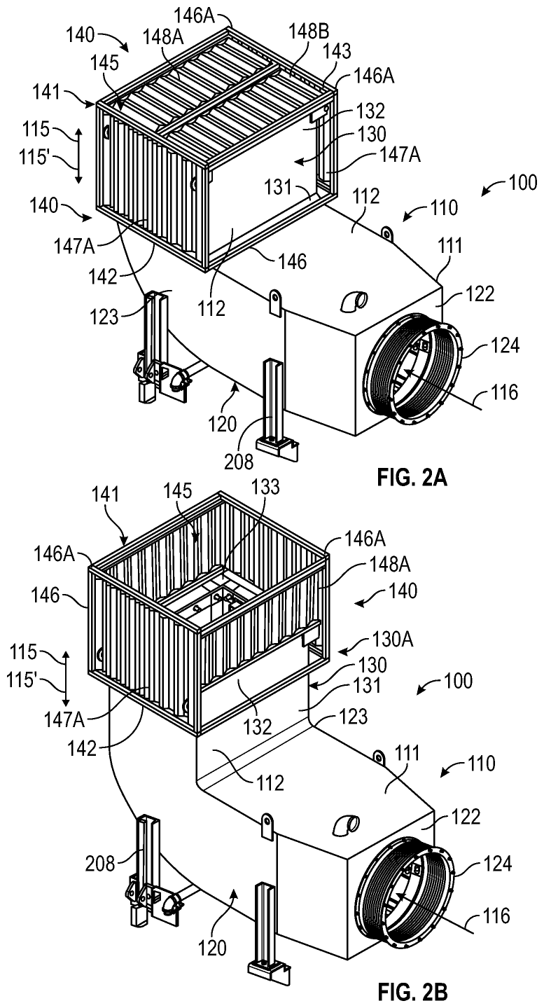

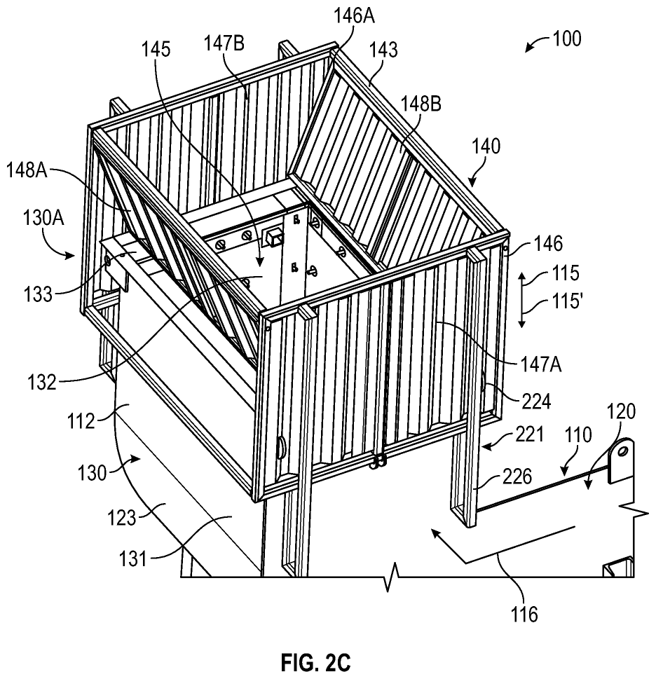

As further illustrated in FIG. 1, in embodiments, the exhaust noise attenuation and dampening system 100 can include an exhaust duct assembly 110 that may mounted along a portion of the transportation platform; and which will be in communication with the gas turbine engine 20 for receiving flows of exhaust gases therefrom. The exhaust noise attenuation and dampening system further can include an upper attenuation assembly 140 moveably attached to the exhaust duct assembly 110 as indicated in FIGS. 2A-6B and 11A-11D.

In embodiments, the exhaust duct assembly 110 will be coupled to the gas turbine engine and can comprise an elongated body 111 including a side walls 112, and a lower plenum portion 120 and an upper plenum portion 130. In embodiments, such as shown in FIGS. 2A-6B, the upper plenum portion can extend away from the lower plenum portion 120, with the upper attenuation assembly 140 received over a distal end 131 of the upper plenum portion 130.

In embodiments, as shown in FIGS. 2A-6B, the lower plenum portion 120 can have a proximal end 122 and a distal end 123, and can extend a first distance between the respective proximal and distal ends thereof. The upper plenum portion 130 is shown in some configurations as extending at an angle, and for a second distance, from the distal end of the lower plenum portion 120. For example, the lower plenum portion 120 can extend along a substantially horizontal direction from its proximal to its distal end, and the upper plenum portion 130 can have a substantially curved or arcuate configuration that extends at an angle with respect to the distal end of the lower plenum portion from a proximal end 131 to a distal or upper end 132. In some example embodiments, the upper plenum portion can project upwardly from the distal end of the lower plenum portion along a substantially vertical axis at an approximately 75°-110° angle with respect to an axis of the lower plenum portion, and in some embodiments, at an approximately 90° angle with respect to the lower plenum portion. Other angles or orientations also can be provided.

As indicated in FIGS. 2A-2B and 5A-6B, an inlet 124 can be defined adjacent the proximal end 122 of the lower plenum portion 120, and can be configured to receive a flow of exhaust gases from the gas turbine. In embodiments, the lower and upper plenum portions 120/130 will define a flow path 116 through the body of the exhaust duct assembly, along which flows of the exhaust gasses can be received from the gas turbine engine, initially being directed longitudinally away from the gas turbine engine, and thereafter being redirected upwardly toward raised discharge position or elevation and away from a ground level of the mobile power unit.

The upper attenuation assembly 140 will be configured to be received over the distal end 131 of the upper plenum portion. The upper attenuation assembly 140 further will be configured to be moveable along a path of travel between a first, non-active or stowed position and a second, extended or deployed position, as indicated by arrows 115/115′, relative to the outlet 132 defined at the distal or upper end 131 of the upper plenum portion 130, defining an extended flow path for the flows of exhaust gases received from the gas turbine engine received and passing through the lower and upper plenum portions of the exhaust duct assembly, whereby the exhaust gasses redirected in a substantially upward/vertical direction away from the surface of the transportation platform and away from ground level.

When the upper attenuation assembly 140 is in its deployed position, the exhaust noise and attenuation dampening system 100 enables the exhaust gases received from a gas turbine engine to be released at a discharge position having a higher elevation with respect to ground level as illustrated in FIGS. 2B, 2C, 3B, 4B, 5B, and 6B. The expansion of the flow path 116 of the flow of exhaust gasses to the elevated discharge position further increases the distance or amount of travel of the exhaust gasses within the exhaust noise attenuation and dampening system, enabling a dissipation or lessening of energy of the exhaust gasses while also redirecting the exhaust gasses upwardly and away from the exhaust duct assembly and the gas turbine engine to enable the substantial dampening or attenuation of noise to which workers and other personnel at ground level are exposed and/or experience as the exhaust gases are released to the surrounding environment.

FIGS. 2A-6B illustrate various example embodiments of the upper attenuation assembly 140. In such embodiments, the upper attenuation assembly 140 can include a body 141 having a first or proximal end 142 and a second or distal end 143, and will be configured to be selectively movable between the first, non-active or stowed position (e.g., as shown in FIGS. 2A, 3A, 4A, 5A and 6A), and second, raised or deployed position (e.g., as shown in FIGS. 2B-2C, 3B, 4B, 5B and 6B). The distal end 143 of the body 141 further can include an outlet portion 144 that defines an outlet or exhaust opening 145 of the upper attenuation assembly 140, through which the exhaust gases can be discharged.

In the stowed position, the distal end 143 of the upper attenuation assembly can be positioned proximate to the distal end of the lower plenum 120, with the body 141 of the upper noise attenuation assembly 140 substantially received and seated over the upper plenum portion 130. In the deployed position, the upper noise attenuation assembly 140 can be moved to an extended, elevated position, raised above the distal end of the upper plenum portion so as to define an upper elongated plenum 130A in fluid communication with the lower plenum portion 120. In this deployed position, the outlet or exhaust opening 145 of the upper attenuation assembly 140 is moved to its discharge position spaced away from the distal end of the lower plenum portion at a third distance that is greater than the second distance, further moving the outlet or exhaust opening to a higher elevation and defining an extended flow path along which the exhaust gases will be directed for discharge at the higher elevation or extended discharge portion with respect to ground level.

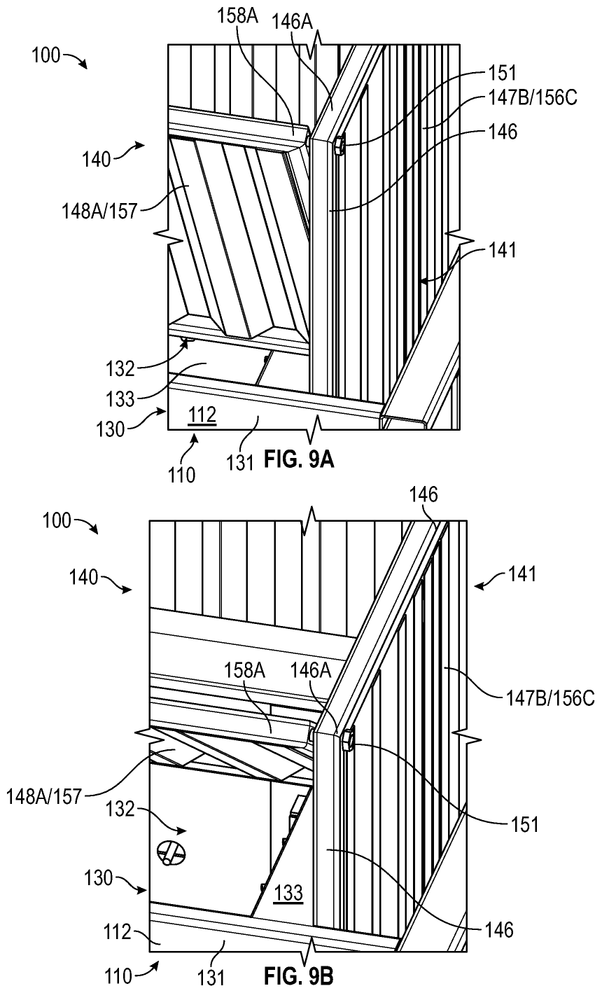

In one embodiment shown in FIGS. 2A-2B, the body 141 of the upper attenuation assembly 140 generally comprises a multi-wall structure, including a frame or support structure 146, a pair of side walls 147A and 147B that can be substantially fixed to the frame, and a pair of moveable side walls 148A and 148B that can be pivotably attached to the frame 146 adjacent an upper or distal end 146A thereof. For example, as illustrated in FIGS. 9A-9B, a first or upper end 149A of each of the moveable walls 148A/148B can be pivotably attached to the upper end 146A of opposed frame members of the frame 146 by pivot pins 151, or other hinge mechanisms enables configured to the pivoting movement of the moveable walls 148A and 148B of the body.

As indicated in FIGS. 2A-2C, the moveable walls can pivot from a first, raised position extending substantially horizontally across the frame and substantially closing an exhaust opening to 145 of the upper noise attenuation assembly and the outlet 132 of the upper plenum portion, downwardly to a second, lowered position, sliding or moving toward alignment with the corresponding walls of the upper plenum and with the moveable walls being arranged in a substantially vertical orientation, as the upper attenuation assembly is raised to its deployed position illustrated in FIGS. 2B and 2C.

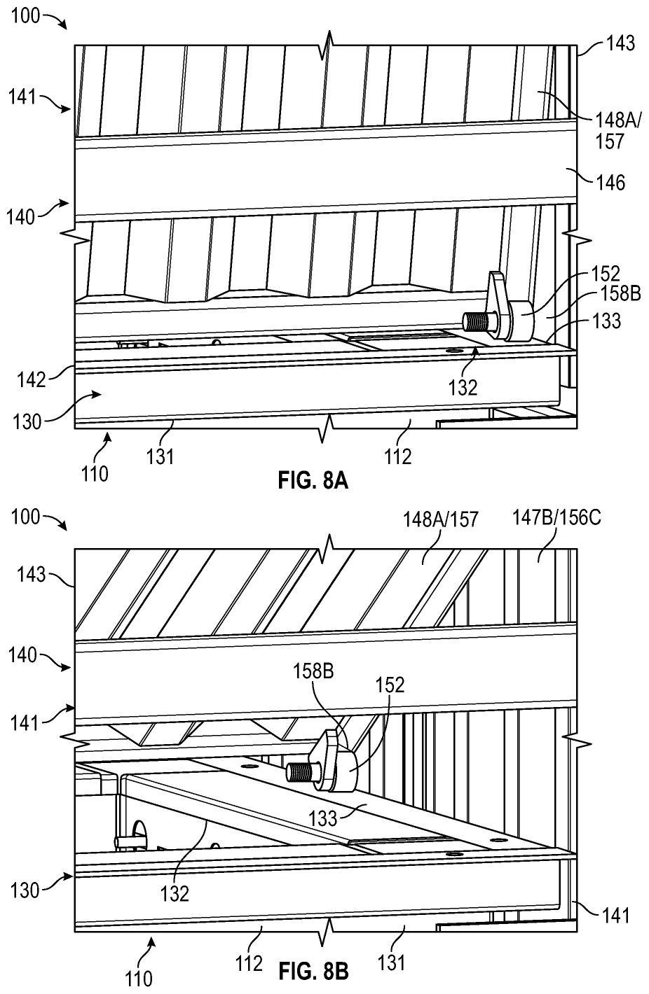

In addition, as shown in FIGS. 8A-8B, rollers 152 can be rotatably mounted to second ends 149B of the moveable walls 148A/148B. The rollers 152 can ride or roll along upper surfaces 133 extending along opposite sides of the outlet portion 132 at the distal end 131 of the upper plenum portion 130. As the upper attenuation assembly is raised and lowered between its stowed and deployed positions, the rollers 152 will move along upper surfaces 133 extending along the distal end and about the outlet portion 132 of the upper plenum portion 130 to guide the pivoting movement of the moveable walls 148A and 148B between their raised and lowered positions.

In their raised positions e.g., when the upper attenuation assembly is in its stowed position seated over the walls of the upper plenum position (such as shown in FIG. 2A), the moveable walls can act as a cover for the outlet opening of the upper plenum portion 130, to substantially prevent ingress of rain, snow, debris, etc., such as during periods of nonuse.

When the moveable walls have been pivoted or moved downwardly into their lowered open position, the exhaust opening 145 of the upper noise attenuation assembly is opened or exposed to enable the exhaust gasses to be discharged into the atmosphere. In other embodiments, the moveable walls 148A/148B, when lowered, and can be oriented at an angle, such as shown in FIG. 2C, with respect to the walls of the upper plenum portion, to help facilitate expansion of the exhaust gases while also direct the exhaust gases further upwardly and away from an intake of the gas turbine engine.

As generally illustrated in FIG. 2B, when the upper attenuation assembly is in its stowed position seated along the outlet and walls of the upper plenum portion the moveable walls 148A/148B can be pivoted downwardly from their raised position covering the exhaust opening to a fully opened position with the moveable walls sliding inwardly and downwardly with their second or distal ends moving toward substantial alignment with corresponding walls of the upper plenum portion so that they extend substantially parallel to the walls of the upper plenum portion of the exhaust duct assembly.

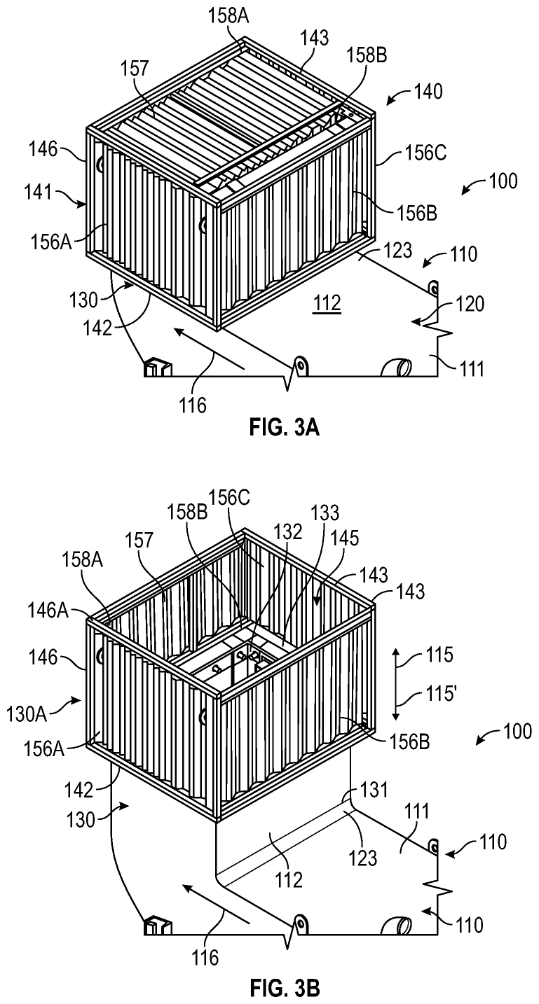

FIGS. 3A-3B illustrate an alternative embodiment or configuration of the upper attenuation assembly 140in which, the body 141 of the upper attenuation assembly includes a series of three fixed walls 156A-156C, and a moveable or intermediate wall 157. As shown in FIG. 3A, the moveable wall 157 can be pivotably attached to the frame 142 of the body at first end 158A thereof, such as via pivot pins 151 or other hinge mechanism, and to rollers 152 as shown in FIGS. 8A and 8B, at the second end 158B (FIGS. 3A-3B) thereof.

The moveable wall 157 can be pivotably attached along one side e.g., an upstream or downstream side of the body of the upper attenuation assembly, and will be moveable between a first, raised position in which the moveable wall 157 can be positioned in a substantially horizontal alignment, extending across and substantially covering the exhaust opening 145 and the outlet of the upper plenum portion, as shown in FIG. 3A. As the upper attenuation assembly is raised from its first, stowed position to its second, deployed position, the rollers coupled to the second end of the moveable wall 157 will roll or move along the upper surfaces 133 of the outlet portion 132 of the upper plenum portion so as to lower the moveable wall to its opened, operative position with the exhaust opening 145 of the upper noise attenuation assembly being opened/exposed, as shown in FIG. 3B. In embodiments, the intermediate or moveable wall 157 can be pivoted to a fully lowered position, extending substantially parallel to the walls of the upper plenum portion, or can be positioned at an angle, similar to the moveable walls 148A/148B of the embodiment shown in FIG. 2C.

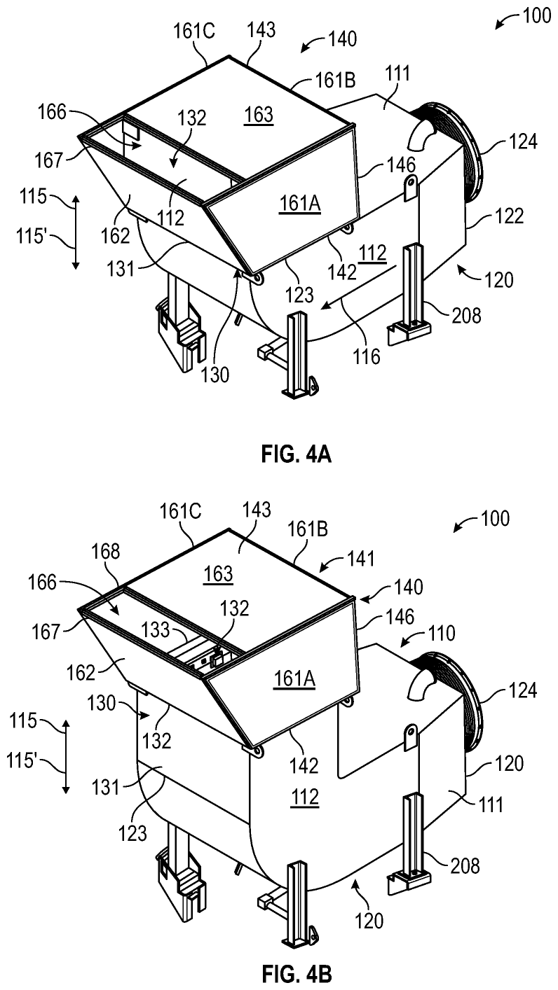

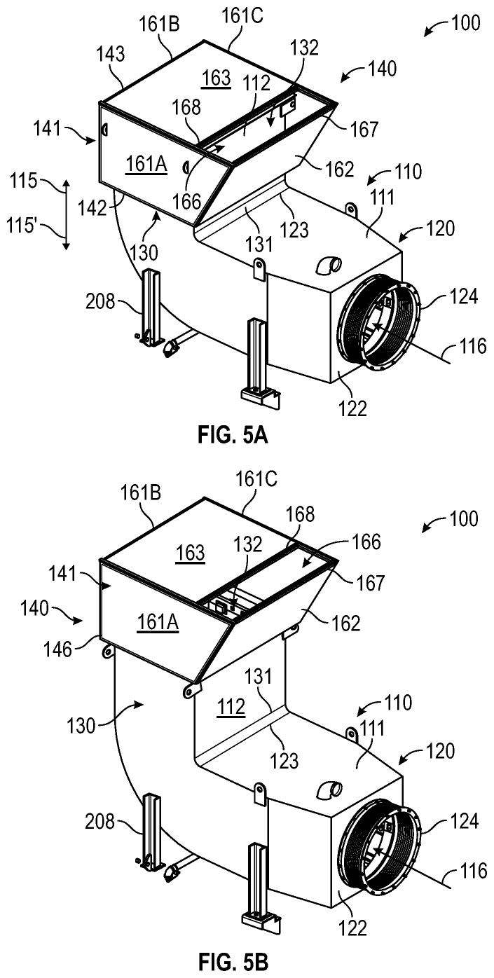

FIGS. 4A-5B illustrate additional embodiments of the upper noise attenuation assembly 140 in accordance with the principles of the present disclosure. As illustrated in FIGS. 4A-5B, in this embodiment, the body 141 of the upper noise attenuation assembly can be configured with a substantially trapezoidal shape. The body 141 can include a series of vertical sidewalls 161A-161C that extend upwardly, substantially parallel to the walls of the upper plenum portion 130 of the exhaust duct assembly; and an angled or sloped wall 162 that extends upwardly and outwardly away from the upper plenum portion at an angle, (e.g., an angle of between about 20° to about 80°, and in embodiments, about 30° to about 10°, about 40° to about 60°, or about 45° to about 50°. As indicated in FIGS. 4A-4B, the sloped wall 162 can be located along a downstream or rearward side of the body, projecting upwardly and outwardly at an angle therefrom. Alternatively, as shown in FIGS. 5A-5B, the sloped 162 can be provided along a front or upstream side of the body.

The body 141 further will include an upper or top wall 163 at the upper end of the body, as shown in FIGS. 4A-5B, which can be mounted to the upper ends of the sidewalls 161A-161C, extending therebetween. The upper wall can be configured so as to substantially fit over the upper plenum portion closing the outlet thereof such that when the upper attenuation assembly is in its first, stowed position, where the upper wall against and substantially covering the outlet 132 of the upper plenum portion.

As further illustrated in FIGS. 4A-5B, an exhaust opening 166 can be defined between an upper end 167 of the sloped wall 162 and a terminal edge 168 of the upper wall 163 When the upper attenuation assembly is in its slowed position, the sloped wall 162 and sidewalls 161A-161C will be arranged about the side walls of the upper plenum portion, with the upper wall 163 seated over the outlet 132 such that communication with, or access to the exhaust opening from the outlet of the upper plenum portion 130 is substantially blocked. As the upper attenuation assembly is raised to its deployed position, the exhaust opening 166 will be raised above the outlet 132 of the upper plenum portion 130 such that the exhaust gasses are enabled to flow along the extended flow path through upper and lower plenum portions and the body of the upper attenuation assembly, for release or discharge through the exhaust opening 166.

As the exhaust gasses move through the body of the upper attenuation assembly, the exhaust gasses are directed upwardly and can impinge against the bottom surface of upper wall 163 and be further redirected along the bottom surface of the upper wall to the exhaust opening 166 where the exhaust gasses can be discharged in an upward and outwardly angled direction. As a result, the discharge of the exhaust gases, and the noise resulting therefrom, provided is at a higher elevation and is directed away from the intake of the gas turbine engine to reduce or attenuate noise levels experienced at ground level.

As a result of the impingement and redirection of the exhaust gasses against the bottom surface of the upper wall increases, further turbulence can be introduced into the flow of exhaust gasses as the exhaust gasses are moved along the expanded flow path, which can facilitate increased dissipation of energy with the flow of exhaust gasses helping to dampen noise resulting from the release of the exhaust gases. Thereafter, the exhaust gasses can be released to atmosphere at a discharge position or location that is at a raised or extended elevation above ground level and can be redirected away from other operative components of the mobile power unit (e.g., away from the gas turbine engine, or away from other components) via the sloped wall defining an outwardly angled pathway to provide a reduction or attenuation of noise to which personnel at ground level may be exposed. When the upper attenuation assembly is moved to its stowed position, the upper wall 163 can cover the outlet of the upper plenum portion to effectively close and protect the outlet of the upper plenum portion from entry of water, snow, debris, etc., when not in use.

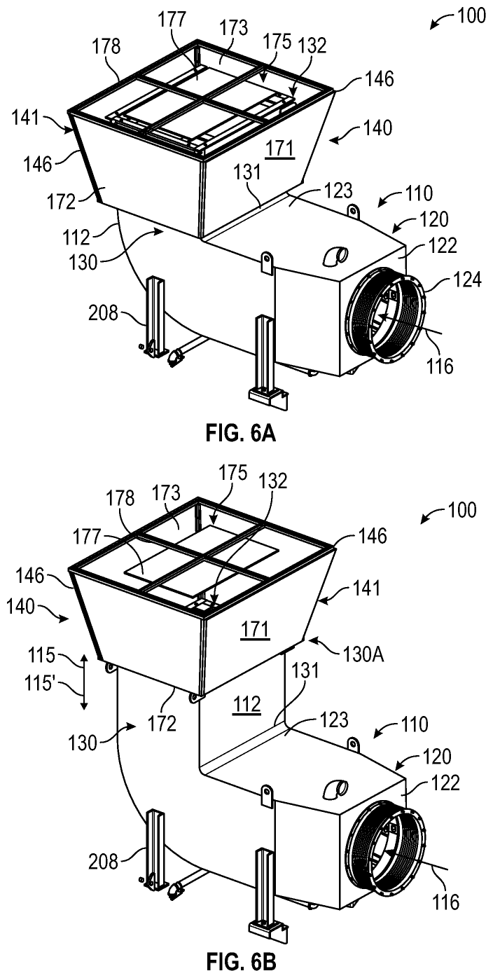

FIGS. 6A and 6B illustrate another embodiment of an upper noise attenuation assembly 140 according to the principles of the present disclosure. In the embodiments shown in FIGS. 6A and 6B, the body 141 of the upper noise attenuation assembly can have a body 141 a series of angled walls 171 that extend upwardly and outwardly from a first or proximal end 172 and to a second or distal end 173 that defines an outwardly flaring exhaust opening 175. The body further can include a frame 176 which can be mounted adjacent the distal ends 173 of the walls 171; and a cover or top plate 177 mounted to and supported by a series of crossmembers 178 attached to and extending across the exhaust opening 175, being supported between the distal ends of the walls.

The cover or top plate 177 generally can be arranged in a substantially horizontally extending orientation, and can be configured so as to seal over and cover the outlet defined at the distal end of the upper plenum portion of the exhaust duct assembly. When the upper attenuation assembly 140 is in its lowered position, as shown in FIG. 6A, the cover 177 can be lowered to a position so as to substantially seat against the outlet 132 of the upper plenum portion, substantially covering the outlet to protect the outlet from entry of water, snow, debris, etc., during periods of nonuse.

As the upper attenuation assembly is raised to its deployed position, as shown in FIG. 6B, the cover 177 moves away from the outlet 132, opening fluid communication between the outlet and the exhaust opening, while also extending the flow path for the exhaust gasses so that the exhaust gasses are discharged or released to atmosphere at a discharge position elevated further above ground level. In addition, the expanded exhaust opening 175 defined by the trapezoidal construction of the body of the embodiment of the upper attenuation assembly 140 shown in FIGS. 6A and 6B, can help enable the exhaust gasses to spread or expand, further promoting a dissipation of energy, which also can help reduce noise generated thereby.

As illustrated in FIGS. 2A-6B, the walls of the body of the upper noise attenuation assembly 140 generally will be constructed of a material configured to withstand elevated temperatures and can comprise various high strength, lightweight materials. For example, the walls can be constructed with a stainless steel frame and stainless steel sheets configured to withstand extreme climate conditions. It is further contemplated that the components (e.g., the exhaust duct assembly and upper attenuation assembly of the exhaust attenuation system 100 will be constructed of materials that are capable of withstanding extreme temperatures, such as for example and without limitation, to about 1250º F. (676° C.), or greater, that are associated with exhaust gases exiting gas turbine engines such as shown in FIG. 1. The body also can include other construction materials such as mild steel and/or aluminum. In embodiments, a high temperature paint can be applied to avoid rust or other effects due to exhaust and exposure. In addition, as shown in FIGS. 2A-3B, the walls of the body can have a corrugated construction, and in other embodiments, (e.g., as shown in FIGS. 4A-6B) the walls can be constructed of flat sheets on the other surface and inner surface with sound attenuation materials applied thereto, including but not limited to mineral wool or other dampening materials that are also configured to be able to withstand high temperatures.

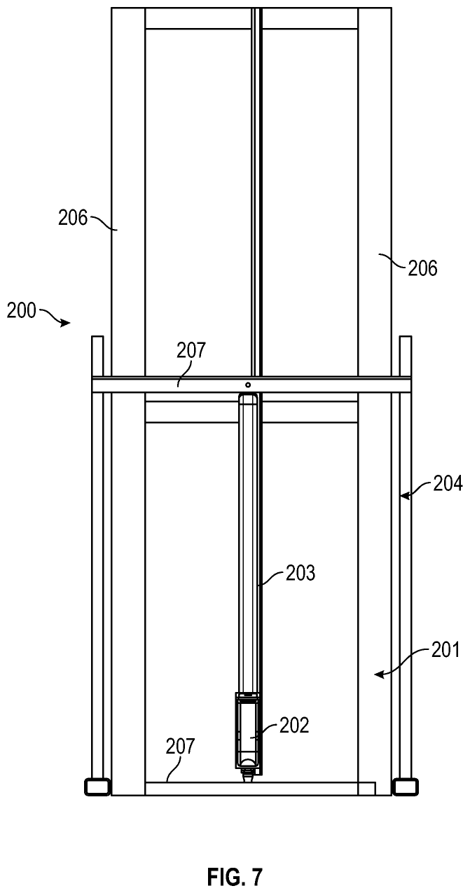

In embodiments, the exhaust noise attenuation and dampening system further will include a conveying system 200 (FIGS. 7 and 10A-11D) that can be configured to move the upper attenuation assembly 140 between its first, stowed position and its second, deployed position, as illustrated in FIGS. 2A-6B. In embodiments, the conveying system 200 can comprise a vertical conveying system or assembly adapted to move the upper attenuation assembly along a substantially vertically oriented path of travel 115/115′.

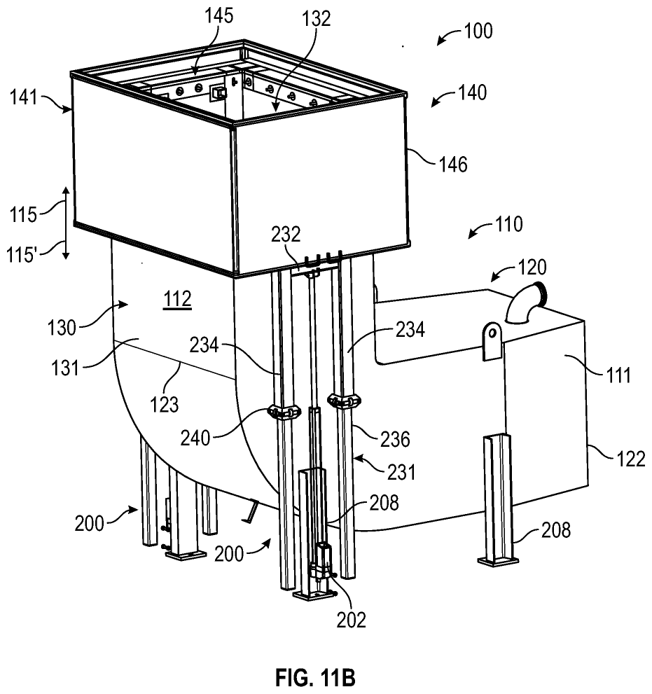

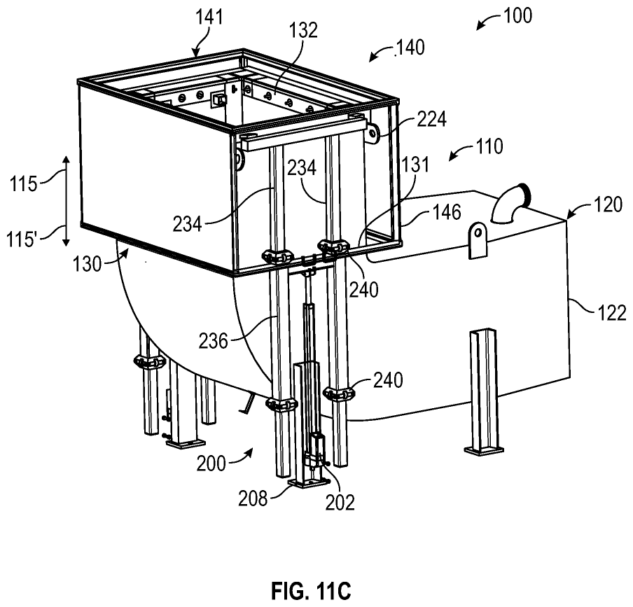

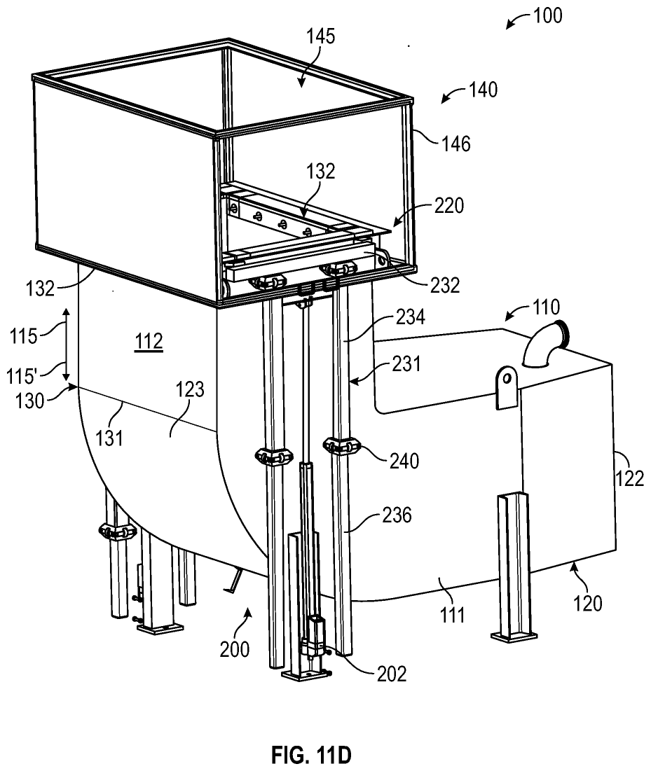

In one example construction, as illustrated in FIG. 7, the conveying system 200 can include a frame 201, one or more actuating mechanisms 202, a moving support 203, and a guide system 204 that can include one or more braces or similar supports. In addition, in some embodiments, the frame 201 can comprise pairs of vertical columns 206, with a cross member or series of cross members 207 that can be arranged at top, middle, and/or bottom portions of the frame. In embodiments, fewer or greater numbers of cross members also can be used. In addition, the frame can be provided with or can be set in anchored mounts 208 (FIGS. 11A-11D) that can be arranged offset to the frame and will be mounted to the transportation platform for securing the conveying system 200 into the transportation platform duct assembly and adjacent the exhaust upper attenuation assembly.

In embodiments, the moving support 203 can include two or more upright supports 209 and a series of guide/wheels 211. In embodiments, two to four guide wheel blocks can be provided along the upright supports 209; and additionally, in some embodiments, a header 212 or other cross wise extending support also can be provided between the uprights. The moving support 203 further generally can comprise a moving component of the conveying system and can couple to the frame of the body of the upper attenuation assembly, for example, along two fixed walls thereof (e.g., as shown at 147A/147B in FIGS. 2A and 2B).

In embodiments, the guide system can include guide wheels (e.g., wheels, rollers, slides, bearings or other guide members) 213 can be located along the frame, being moveable along or within the vertical columns of the frame 201. Guide wheel blocks can be located adjacent the guide wheels to help support and guide the guide wheels along the vertical columns. Stops can be positioned adjacent a lower level and adjacent an upper level of the frame and will be configured such that upward and downward travel of the moving support can be limited by the stops. In embodiments, the stops can be made adjustable for adjusting or tuning an amount of travel of the moving support, and thus an amount or distance of travel of the upper attenuation assembly. Still further, in embodiments, bracing can be provided at a lower or bottom portion of the frame and adjacent a top or upper portion of the frame; and, in embodiments, can include channels and mounting plates attached to two or more of support legs 117 of the body 111 of the exhaust duct assembly 110, such as indicated in FIGS. 2A and 2B.

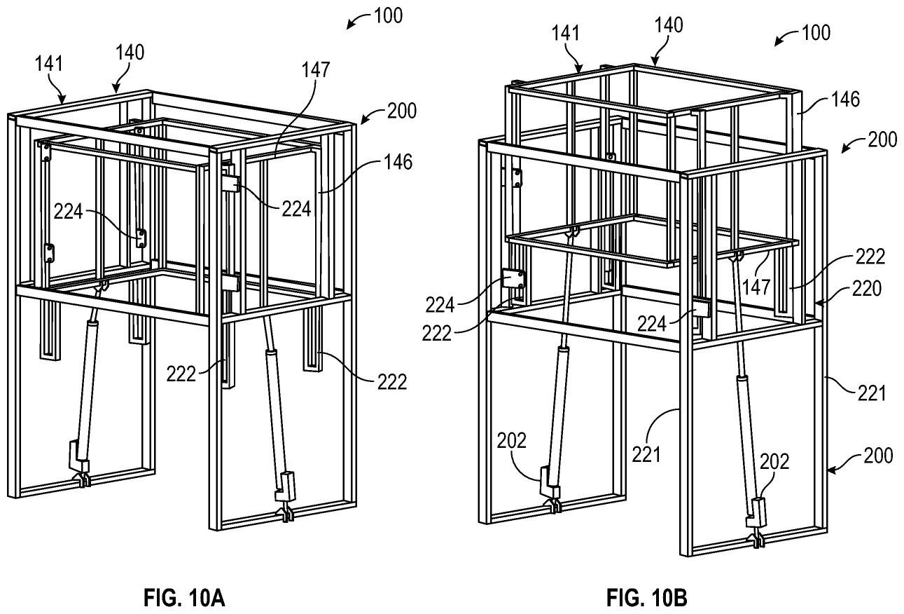

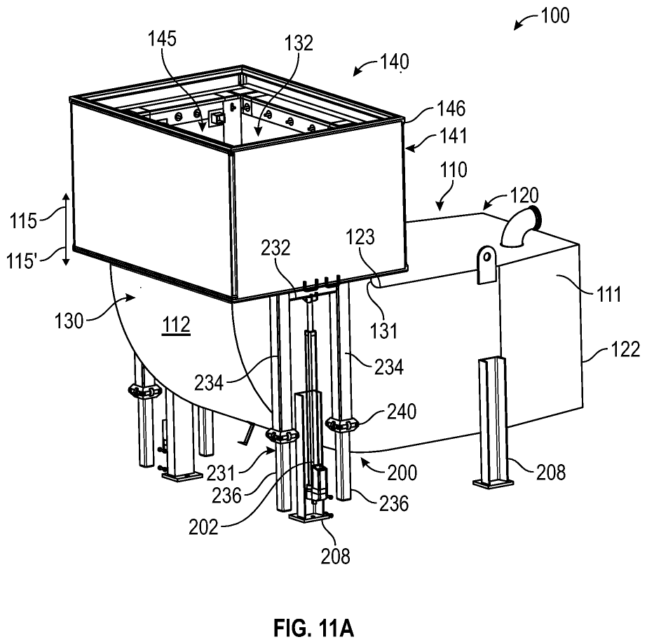

FIGS. 10A and 10B illustrate an additional embodiment of the conveying system 200 for controlling movement of the upper attenuation assembly 140 between its first, stowed position and its second, deployed position. In this embodiment, the conveying system can include a frame 220 with a guide system 221, which can comprise series of tubes or channel members 222 arranged along the sides of the frame 220. In embodiments, the guide system can be provided along the outside of the frame 220 with the frame received therein; and in some embodiments the guide system can be located within the frame.

In addition, the frame 220 of the conveying system can define a substantially straight path of movement for the upper attenuation assembly to travel in a substantially vertical direction along a maximum and minimum length of travel. The body of the noise attenuation assembly can be received within the frame 220 and engage/move along the guide system 221 of the conveying system illustrated in FIGS. 10A and 10B, and can be coupled to actuating mechanisms 202 positioned on opposite sides of the frame 220. The frame 220 and guide system 221 can include a series of guides 229 of the conveying system, for example, plates, rollers or other, similar guiding mechanisms, that can be attached to one or more tubes 222. The guides can be received within guide slots defined along the frame of the body of the upper attenuation assembly.

As the upper attenuation assembly is moved between its stowed position and its deployed position, the guides attached to the frame of the upper attenuation assembly can move along the guide slots to help guide and control the vertical movement or travel of the upper attenuation assembly. In embodiments, the frame of the upper attenuation assembly can include guide slots or pathways, and the frame of the conveying system can include guides such as plates or rollers that can be received within the guide slots of the frame of the upper attenuation assembly to help guide the upper attenuation assembly along is vertical path of travel with minimal resistance and to help support the load generated by the upper attenuation assembly book launched longitudinally and laterally. In the present embodiments, the upper attenuation assembly further can be supported by the actuating mechanisms 202.

Still another embodiment of a conveying system 200 for guiding movement of the upper attenuation assembly between its stowed and deployed positions is illustrated in FIGS. 11A-11D. In this embodiment, the actuating mechanisms 202 of the conveying system 200 can be mounted or supported along or adjacent exhaust duct support legs. In embodiments, a pair of actuating mechanisms 202 can be provided, with one on each side of the exhaust duct assembly. In the present embodiment, the conveying system can include a frame 230 that can include a series of telescoping vertical supports 231, with cross members 232 at an upper end thereof. Each of the vertical supports 231 can include an inner tube or support 234 and an outer tube or support 236 that is received over its inner tube 234 in a telescoping arrangement.

Bearing assemblies 240 can be coupled to the outer telescoping tubes 236, for example, at upper and lower ends thereof, and can engage the sides of the inner tubes 234 to help guide the outer tubes along their inner tubes for a movement of the upper attenuation assembly along its vertical path of travel. In embodiments, the bearing assemblies can include a series of roller bearings, linear bearings, rollers, or other guides, including slides or plates or other members formed from a reduced friction material. As the conveying system is actuated to move the upper attenuation assembly along its path of travel, the bearings assemblies help guide the sliding motion of the outer telescoping tubes to over/along their inner tubes with substantially minimal resistance, while also guiding the movement of the upper attenuation assembly in a substantially consistent, up and down motion along its path of travel 115/115′.

As shown in FIGS. 7.1 and 10A-13, in embodiments, the actuating mechanisms 202 can include a hydraulic or pneumatic cylinders. In embodiments, where hydraulic or pneumatic cylinders are used, the hydraulic or pneumatic cylinders can comprise double-acting cylinders, which do not require cables, chains, sheaves, sprockets, bearings, or other similar components. The speed of activation of such double acting cylinders can be controlled by proportional directional control valves such as Danfoss PVG or Parker VP 120 control valves. A hydraulic line velocity fuse can be attached to the hydraulic hose fittings at the hydraulic cylinder to regulate the flow of hydraulic fluid in and out of the cylinders, and can be used to prevent uncontrolled descent in the event of a hydraulic hose rupture.

In addition, in other embodiments, the actuating mechanisms 202 can comprise other types of actuators, such as electric actuators, e.g., motors such as servo, stepper or torque motors, rotary actuators, line or actuators, or other drive mechanisms.

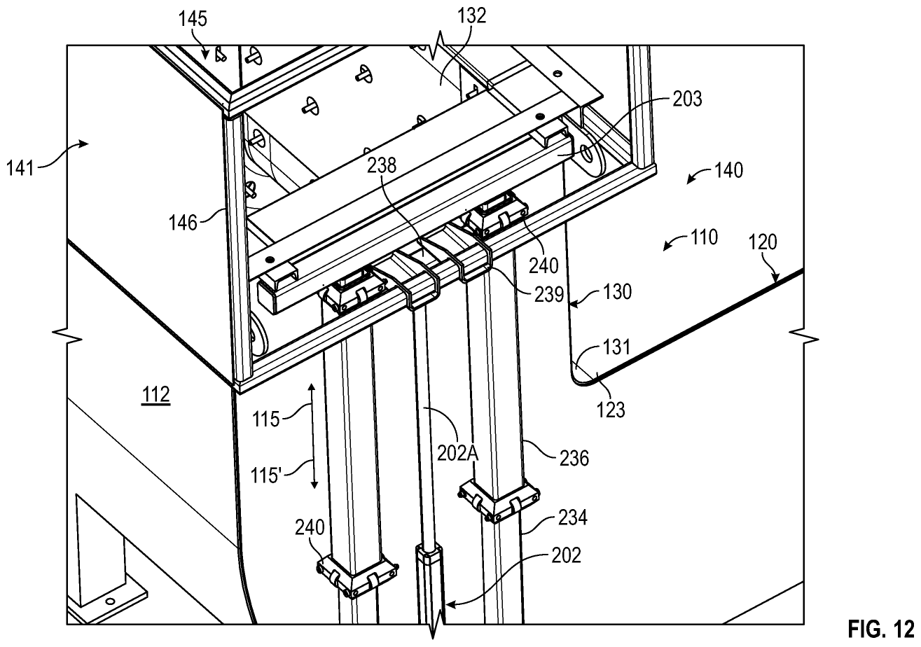

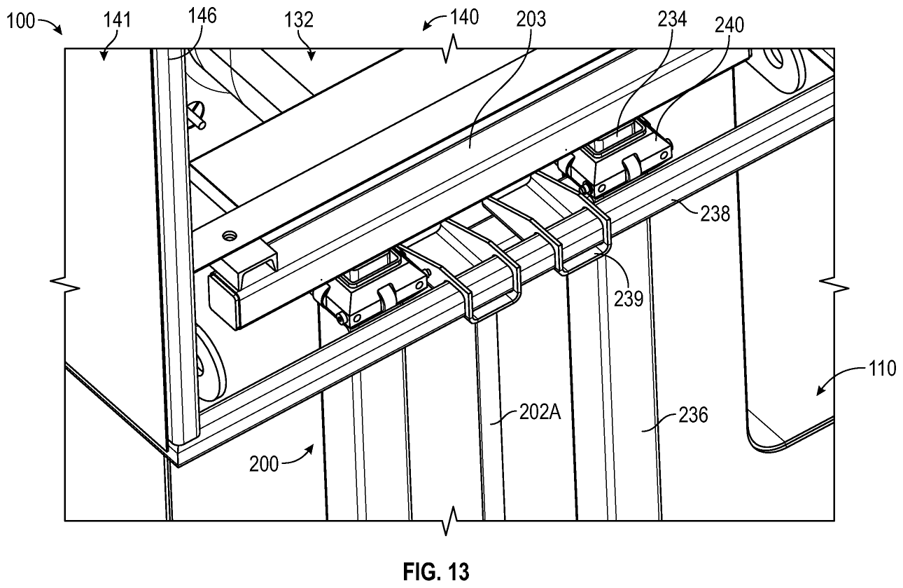

In embodiments, the activating mechanisms can attach to the bottom of the conveying system frame, and can each include at least one actuator shaft or cylinder rod 202A. As shown in FIGS. 10A-11A, the actuating mechanisms can include hydraulic or pneumatic cylinders having cylinder rods can be coupled to the frame of the upper attenuation assembly, e.g., such as by plate or cross beam 238. In embodiments, cross beam further can include projecting portions 239 configured to engage against the bottom surface of a cross member extending between each of the telescoping vertical supports also as shown in FIGS. 12-13. The actuating mechanisms 202 can mount to the conveying system frame with an upper end of the actuator rod be attached to an anchor or clevis of a support moving portion of the conveying system, (e.g., using a cylinder pin, washer, and cotter pin, or other connector when the actuated, the actuator rods of the actuating mechanisms control movement of the upper attenuation assembly along a substantially vertical path of travel between its stowed and deployed positions.

In case of an electric actuating mechanism, (e.g., a motor or an electric linear actuator) the electric actuator can receive power allowing an actuator shaft (e.g., a ball screw or similar shaft) to move up and down causing the moving support to extend and retract the upper noise attenuation system between the stowed and deployed positions. The motion of the shaft actuator can be stopped when it gets to the end of a desired stroke. For example, the actuators can have built in limit switches, or in embodiments, external switches, such as but not limited to Parker ALS switches, with at least one limit switch for the top or upper most limit for the length of travel of the shaft, and a stop switch for the lower most limit of the length of travel of the shaft. Once the limit is reached, the switch can be triggered a signal is sent to stop the actuator. The electric actuator can be a ball screw linear actuator such as a Thomson Electrak actuator, but can be of any other type.

The foregoing description of the disclosure illustrates and describes various exemplary embodiments. Various additions, modifications, changes, etc., may be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanges and applied to other illustrated and non-illustrated embodiments of the disclosure.

1. A hydraulic fracturing unit for pumping a fracturing fluid into a well-head, comprising:
a chassis;
a fracturing pump positioned on the chassis and configured to pump the fracturing fluid into the well-head;
a gas turbine engine positioned on the chassis, and operatively connected to the fracturing pump; the gas turbine engine configured to receive a fuel mixture and to combust at least a portion of the fuel mixture;
wherein the gas turbine engine drives operation of the fracturing pump to pump the fracturing fluid into the wellhead;
an exhaust noise attenuation system, comprising:
an exhaust duct assembly including a lower plenum portion coupled to the gas turbine engine, and configures to receive a flow of exhaust gases therefrom, and an upper plenum portion downstream from the lower plenum portion and having an exhaust opening at a distal end thereof;
wherein a flow path along which the flow of exhaust gases is moved is defined through the lower and upper plenum portions;
an upper attenuation assembly received over the distal end of the upper plenum portion; and
a conveying system coupled to the upper attenuation assembly and configured to the upper attenuation assembly between a stowed position substantially covering the exhaust opening of the upper plenum portion, and a second position enabling release of exhaust from the exhaust duct;
wherein upon movement of the upper attenuation assembly to its deployed position, the flow path of the exhaust gas through the exhaust duct and upper attenuation assembly is extended to increase a length of travel of the flow of exhaust gases and redirect the flow of exhaust gases away from ground level to facilitate a reduction of noise generated by release of the exhaust gases experienced at ground level.

2. The hydraulic fracturing unit of claim 1, wherein the conveying system comprises a frame and at least one actuating mechanism coupled to the upper attenuation assembly and configured to move the upper attenuation assembly along a substantially vertical path of travel between its stowed and deployed positions.

3. The hydraulic fracturing unit of claim 2, wherein the at least one actuating mechanism comprises a hydraulic or pneumatic cylinder, an electric actuator, rotary actuator, or motor.

4. The hydraulic fracturing unit of claim 2, wherein the conveying system further comprises a guide system within which the upper attenuation assembly is received, the guide system being configured to guide the upper attenuation assembly along its substantially vertical path of travel.

5. The hydraulic fracturing unit of claim 1, wherein the upper attenuation assembly comprises a body having a frame, a plurality of substantially vertically extended walls, at least one moveable wall plurality attached to the frame, and one or more rollers connected to the at least one moveable wall and configured to move along a portion of the upper plenum portion adjacent the exhaust opening thereof so as to move the at least one moveable wall between a closed position substantially covering the exhaust opening and an open position to expose an outlet or exhaust opening defined at an upper end of the upper attenuation assembly and through which the flow of exhaust gases is discharged when the upper attenuation assembly in its second position.

6. The hydraulic fracturing unit of claim 5, wherein the at least one moveable wall comprises first and second moveable walls, each pivotally attached at an upper end of the frame of the body of the upper attenuation assembly.

7. The hydraulic fracturing unit of claim 1, wherein the upper attenuation assembly comprises a body having a plurality of substantially vertically extending side walls, at least one angled wall, and a substantially horizontally extending top wall; wherein an outlet or exhaust opening is defined between the top wall and an upper end of the at least one angled wall; and wherein as the flow of exhaust gases is directed along the extended flow path, the exhaust gases are redirected upwardly and at an angle away from the exhaust assembly.

8. The hydraulic fracturing unit of claim 1, wherein the upper attenuation assembly comprises a body having a plurality of sloping side walls and a top plate positioned therebetween and configured to at least partially cover the exhaust opening of the upper plenum portion when the upper attenuation assembly is in its stowed position.

9. The hydraulic fracturing unit of claim 1, wherein the upper attenuation assembly comprises a body having a frame and series of substantially vertically extending walls; wherein the conveying system comprises a series of actuating mechanisms coupled to the of the body of the upper attenuation assembly and configured to move the frame along a substantially vertical path of travel; and further comprising a guide system within which the body of the upper attenuation assembly is received, the guide system including a series of guide members configured to guide movement of the upper attenuation assembly as the upper attenuation assembly is moved between its stowed and deployed positions.

10. The hydraulic fracturing unit of claim 1, wherein the conveying system comprises a plurality of telescoping supports coupled to the upper attenuation assembly, and at least one actuating mechanism coupled to the upper attenuation assembly and configured to move the upper attenuation assembly along a substantially vertically path of travel between its stowed and deployed positions.

11. An exhaust noise attenuation system comprising:
an exhaust duct assembly comprising:
a lower plenum portion having a proximal end and a distal end, and an inlet adjacent its proximal end configured to receive a flow of exhaust gases from an engine; and
an upper plenum portion having a proximal end adjacent the distal end of the lower plenum portion and a distal end terminating at outlet;
wherein a flow path for the flow of exhaust gases is defined through the upper and lower plenum portion; and
an upper noise attenuation assembly movably connected to the upper plenum portion, the upper noise assembly comprising;
a body having a proximal end, distal end, a plurality of walls, and an exhaust opening defined at the distal of the body; and
a conveying system including one or more actuators coupled to the body and configured to selectively move the upper noise attenuation assembly between a stowed position, at which the upper attenuation system is configured to substantially cover the outlet of the upper plenum portion, and a second position, at which the upper attenuation assembly is elevated above the exhaust opening of the upper plenum portion so as to define an extended flow path in fluid communication with the outlet of the upper plenum portion and along which the flow of exhaust gases is for discharge at a raised elevation above ground level so as to reduce a level of noise heard at the ground level.

12. The exhaust noise attenuation system of claim 11, wherein the exhaust duct assembly and upper noise attenuation assembly are mounted along a trailer of a mobile power generation unit.

13. The exhaust noise attenuation system of claim 11, wherein the upper attenuation assembly comprises a body having a frame, a plurality of substantially vertically extended walls, at least one moveable wall plurally attached to the frame, and one or more rollers connected to the at least one moveable wall and configured to move along a portion of the upper plenum portion adjacent the exhaust opening thereof so as to move the at least one moveable wall between a closed position substantially covering the exhaust opening and an open position to expose an outlet or exhaust opening defined at an upper end of the upper attenuation assembly and through which the flow of exhaust gases is discharged when the upper attenuation assembly in its second position.

14. The exhaust noise attenuation system of claim 13, wherein the at least one moveable wall comprises first and second moveable walls, each pivotally attached at an upper end of the frame of the body of the upper attenuation assembly.

15. The exhaust noise attenuation system of claim 11, wherein the conveying system comprises a frame and at least one actuating mechanism coupled to the upper attenuation assembly and configured to move the upper attenuation assembly along a substantially vertical path of travel between its stowed and deployed positions.

16. The exhaust noise attenuation system of claim 15, wherein the at least one actuating mechanism comprises a hydraulic or pneumatic cylinder, an electric actuator, rotary actuator, or motor.

17. The exhaust noise attenuation system of claim 11, wherein the upper attenuation assembly comprises a body having a plurality of substantially vertically extending side walls, at least one angled wall, and a substantially horizontally extending top wall; wherein an outlet or exhaust opening is defined between the top wall and an upper end of the at least one angled wall;
and wherein as the flow of exhaust gases is directed along the extended flow path, the exhaust gases are redirected upwardly and at an angle away from the exhaust assembly.

18. The exhaust noise attenuation system of claim 11, wherein the upper attenuation assembly comprises a body having a plurality of sloping side walls and a top plate positioned therebetween and configured to at least partially cover the exhaust opening of the upper plenum portion when the upper attenuation assembly is in its stowed position.

19. The exhaust noise attenuation system of claim 11, wherein the conveying system comprises a plurality of telescoping supports coupled to the upper attenuation assembly, and at least one actuating mechanism coupled to the upper attenuation assembly and configured to move the upper attenuation assembly along a substantially vertically path of travel between its stowed and deployed positions.

20. The exhaust noise attenuation system of claim 11, wherein the upper attenuation assembly comprises a body having a frame and series of substantially vertically extending walls; wherein the conveying system comprises a series of actuating mechanisms coupled to the of the body of the upper attenuation assembly and configured to move the frame along a substantially vertical path of travel; and further comprising a guide system within which the body of the upper attenuation assembly is received, the guide system including a series of guide members configured to guide movement of the upper attenuation assembly as the upper attenuation assembly is moved between its stowed and deployed positions.

21. An exhaust noise attenuation system comprising:
an exhaust duct assembly comprising:
a lower plenum portion defining an inlet for a flow path along which a flow of exhaust gases is received; and
an upper plenum portion downstream of the lower plenum portion and defining a continuation of the flow path; and
an upper noise attenuation assembly located adjacent an outlet defined at a distal end of the upper plenum portion, the upper noise assembly comprising:
a body having a frame, a plurality of walls attached to the frame and an exhaust opening defined at an upper end of the walls and configured to discharge the flow of exhaust gases; and
a conveying system coupled to the body of the upper noise attenuation assembly and configured to selectively move the body along a substantially vertical path of travel so as to move the upper noise attenuation assembly between a stowed position in which fluid communication between the exhaust opening and the flow path is substantially closed, and a deployed position in which the body is moved to an extended position and fluid communication between the exhaust opening and the flow path defined through the lower plenum portion and the upper plenum portion is opened;
wherein when the upper attenuation assembly is in its deployed position, the flow path defined though the lower plenum portion and upper plenum portion is extended such that a length of travel of the flow of exhaust gasses is increased and the exhaust gasses are directed away from the exhaust duct assembly toward a discharge position at a raised elevation above a ground level so as to reduce a level of noise experienced at the ground level.

22. The exhaust noise attenuation system of claim 21, wherein the exhaust duct assembly is mounted on a chassis of a mobile power generation unit, and is in fluid communication with a gas turbine engine mounted on the chassis.

23. The exhaust noise attenuation system of claim 21, wherein the walls comprise one or more moveable walls configured to transition between a first position substantially covering the outlet of the upper plenum portion when the upper noise attenuation assembly is in the stowed position and a second position in which the exhaust opening and the outlet of the upper plenum portion are exposed to enable discharge of the flow of exhaust gases.

24. The exhaust noise attenuation system of claim 23, further comprising pivot pins configured to pivotally couple a first end of the one or more moveable walls to an upper end of the frame such that the one or more moveable walls are pivoted between their first and second positions when the upper noise attenuation assembly is moved between the stowed and deployed positions.

25. The exhaust noise attenuation system of claim 24, wherein as the upper noise attenuation assembly is moved toward its deployed position, the one or more moveable walls move inwardly and downwardly with respect to the upper plenum portion, with the first end of the one or more moveable walls pivoting about the pivot pins toward substantial alignment with corresponding walls of the upper plenum portion so that they extend substantially parallel to the walls of the upper plenum portion of the exhaust duct assembly.

26. The exhaust noise attenuation system of claim 21, further comprising a guide system configured to receive the frame of the upper attenuation assembly, the guide system comprising a plurality of guide members configured to guide movement of the upper attenuation assembly as the upper attenuation assembly is moved between its stowed and deployed positions.

27. The exhaust noise attenuation system of claim 26, wherein the guide system further comprises a plurality of guide wheels being moveable along the guide members of the guide system, and one or more guide wheel blocks located adjacent the guide wheels to help guide the guide wheels along the guide members of the guide system.

28. The exhaust noise attenuation system of claim 27, the guide system further comprises one or more stops positioned along the guide members and configured to limit an amount of travel of the guide wheels; wherein the one or more stops are moveable for adjusting the amount of travel of the upper attenuation assembly.

29. The exhaust noise attenuation system of claim 21, wherein the conveying system comprises one or more actuators connected to the body of the upper noise attenuation assembly and configured to selectively move the upper noise attenuation assembly between its stowed position and its deployed position.

30. The exhaust noise attenuation system of claim 21, wherein the plurality of walls comprise a plurality of fixed, substantially vertically extending side walls, at least one angled wall, and a substantially horizontally extending top wall; wherein the exhaust opening is defined between the top wall and an upper end of the at least one angled wall; and wherein when the upper noise attenuation assembly is in its deployed position, the flow of exhaust gases is enabled to move along the extended flow path, and the exhaust gases are redirected upwardly and at an angle away from the exhaust duct assembly.

31. The exhaust noise attenuation system of claim 21, wherein the plurality of walls comprise a series of sloping side walls, and the body further comprises a top plate positioned between the sloping side walls, wherein the top plate is configured to at least partially cover the outlet of the upper plenum portion when the upper attenuation assembly is in its stowed position.

32. The exhaust noise attenuation system of claim 21, wherein the conveying system comprises a series of actuating mechanisms coupled to the of the body of the upper attenuation assembly, the actuating mechanisms configured to move the body along a substantially vertical path of travel; and further comprising a guide system within which the body of the upper attenuation assembly is received, the guide system including a series of guide members configured to guide movement of the body as the upper noise attenuation assembly is moved between the stowed and deployed positions.

33. The exhaust noise attenuation system of claim 21, wherein the conveying system comprises a plurality of telescoping supports coupled to the body of the upper attenuation assembly, and at least one actuating mechanism coupled to the body and configured to move the body along a substantially vertically path of travel so as to move the upper attenuation assembly between its stowed and deployed positions.
